(19) United States
(12) Patent Application Publication
(10) Pub. No.: US 2020/0238773 A1
(43) Pub. Date: Jul. 30, 2020

(54) Bumper Hitch Shield Assembly

(71) Applicant: Doug Francis, Olive Branch, MS (US)

(72) Inventor: Doug Francis, Olive Branch, MS (US)

(21) Appl. No.: 16/260,730

(22) Filed: Jan. 29, 2019

(51) Int. Cl. B60D 1/60; B60R 21/34

(52) U.S. Cl. CPC B60D 1/60; B60R 2021/346; B60R 21/34

(57) ABSTRACT

A bumper hitch shield assembly for inhibiting a person from striking their legs against a trailer hitch includes a clamp that releasably engages a hitch on a vehicle. A plurality of supports is each of the supports is coupled to and extends away from the clamp. A shield is coupled to each of the supports such that the shield is spaced from the clamp. The shield is curved such that the shield extends around a ball on the hitch when the clamp is positioned on the hitch. In this way the shield inhibits a person from striking their legs against the ball when the person walks near the hitch.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to shield devices and more particularly pertains to a new shield device for inhibiting a person from striking their legs against a trailer hitch.

### BRIEF SUMMARY OF THE INVENTION

An embodiment of the disclosure meets the needs presented above by generally comprising a clamp that releasably engages a hitch on a vehicle. A plurality of supports is each of the supports is coupled to and extends away from the clamp. A shield is coupled to each of the supports such that the shield is spaced from the clamp. The shield is curved such that the shield extends around a ball on the hitch when the clamp is positioned on the hitch. In this way the shield inhibits a person from striking their legs against the ball when the person walks near the hitch.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a bumper hitch shield assembly according to an embodiment of the disclosure.

FIG. 2 is a top in-use view of an embodiment of the disclosure.

FIG. 3 is a left side in-use view of an embodiment of the disclosure.

FIG. 4 is an exploded perspective in-use view of an embodiment of the disclosure.

FIG. 5 is a perspective in-use view of an embodiment of the disclosure.

### DETAILED DESCRIPTION OF THE INVENTION

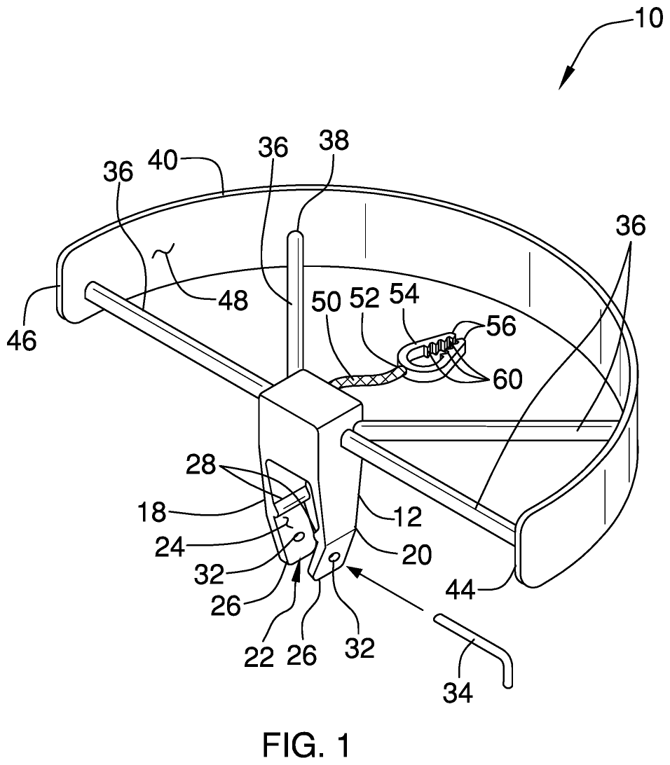

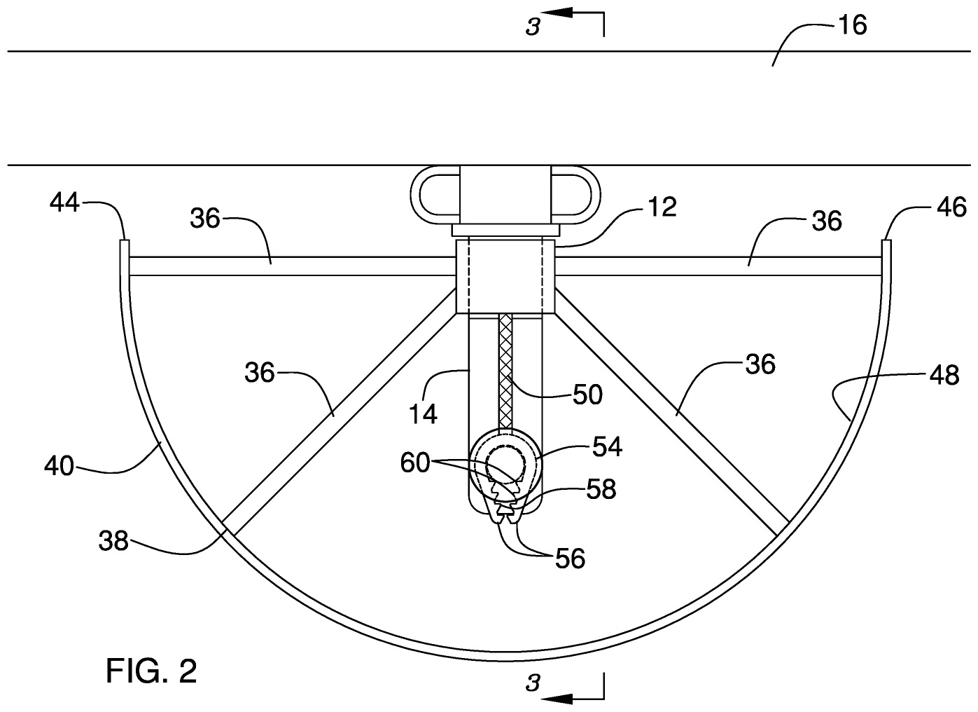

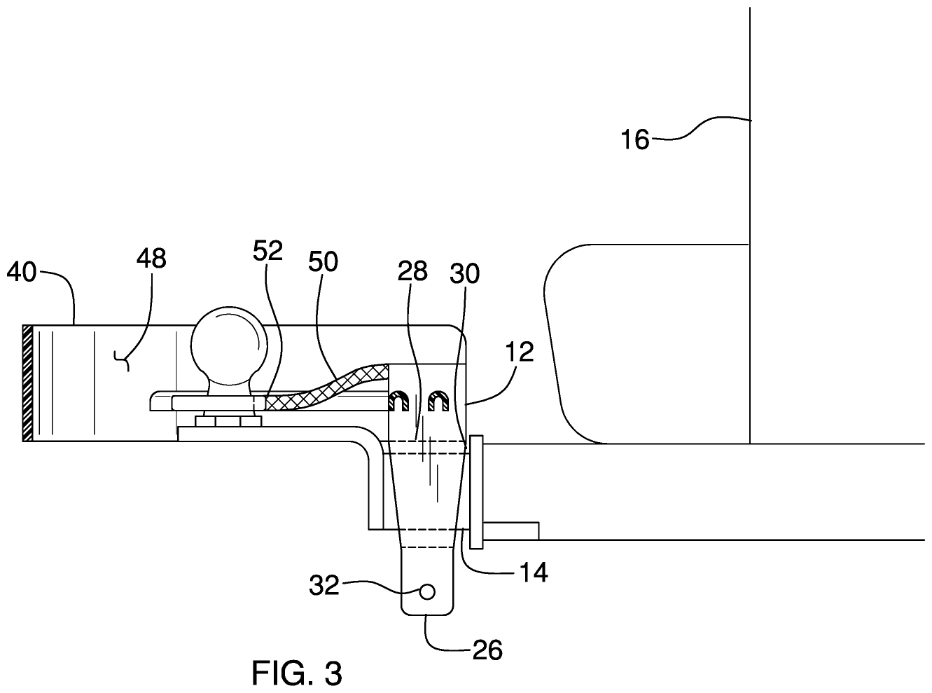

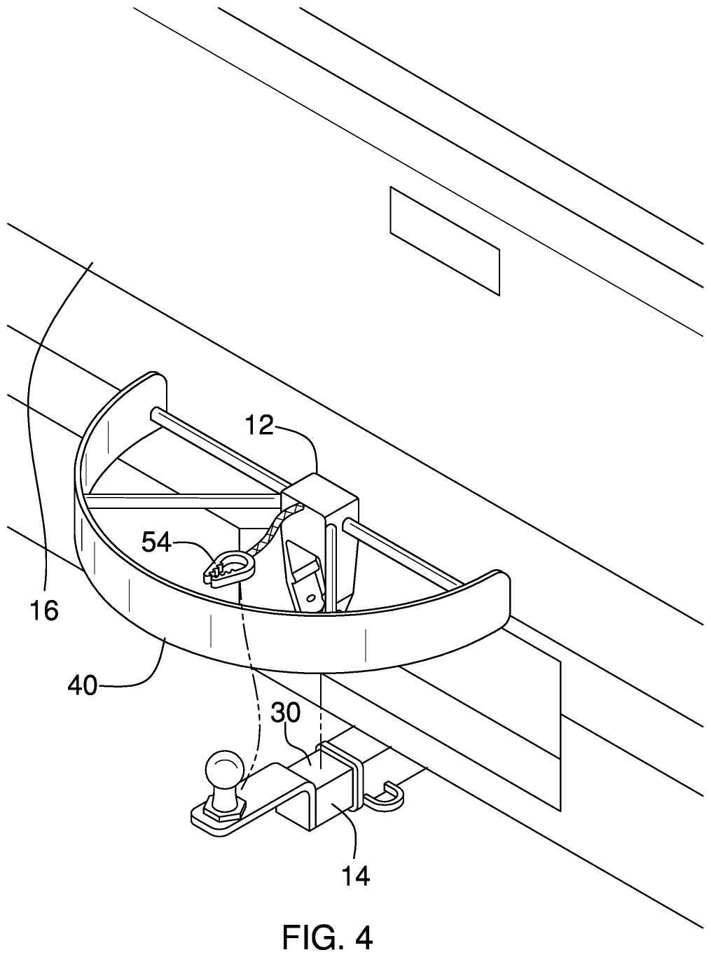

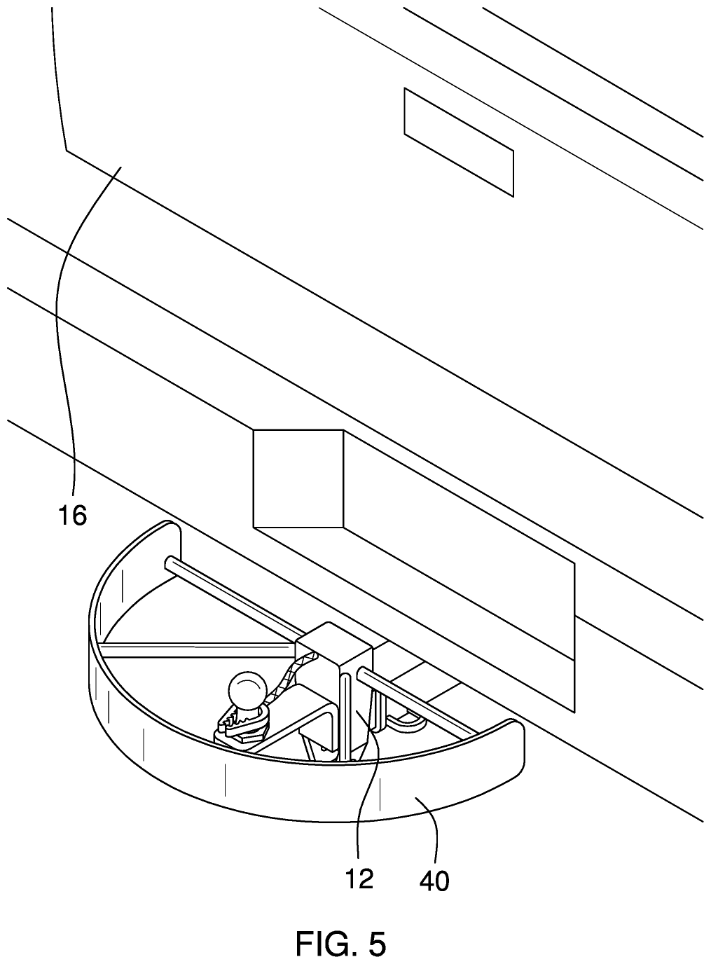

With reference now to the drawings, and in particular to FIGS. 1 through 5 thereof, a new shield device embodying the principles and concepts of an embodiment of the disclosure and generally designated by the reference numeral 10 will be described.

As best illustrated in FIGS. 1 through 5, the bumper hitch shield assembly 10 generally comprises a clamp 12 that releasably engages a hitch 14 on a vehicle 16. The vehicle 16 may be a pickup or the like and the hitch 14 may be a hitch commonly employed on hitch receivers on pickups. The clamp 12 has a first jaw 18 that is spaced from a second jaw 20 to define a hitch space 22 between the first 18 and second 20 jaws.

Each of the first 18 and second 20 jaws has an inwardly facing surface 24 and a distal end 26. Additionally, each of the first 18 and second 20 jaws has a prominence 28 on the inwardly facing surface 24 and the prominence 28 is centrally positioned on each of the first 18 and second 20 jaws. The prominence 28 on each of the first 18 and second 20 jaws abuts a top side 30 of the hitch 14 when the hitch space 22 receives the hitch 14.

Each of the first 18 and second 20 jaws has a pin aperture 32 extending therethrough. The pin aperture 32 is positioned adjacent to the distal end 26 of a respective one of the first 18 and second 20 jaws. Additionally, the pin aperture 32 in each of the first 18 and second 20 jaws is positioned below the hitch 14 when the clamp 12 is positioned around the hitch 14. A pin 34 is provided and the pin 34 is extendable through the pin aperture 32 in each of the first 18 and second 20 jaws when the clamp 12 is positioned around the hitch 14. Thus, the pin 34 inhibits the clamp 12 from being lifted upwardly, and be possibly removed from, from the hitch 14.

A plurality of supports 36 is each coupled to and extends away from the clamp 12. Each of the supports 36 is oriented perpendicular to the clamp 12. Thus, each of the supports 36 is horizontally oriented when the clamp 12 is positioned on the hitch 14. The supports 36 radiate outwardly from the clamp 12 and each of the supports 36 has a distal end 38 with respect to the clamp 12. A shield 40 is coupled to each of the supports 36 such that the shield 40 is spaced from the clamp 12. Moreover, the shield 40 is curved such that the shield 40 extends around a ball 42 on the hitch 14 when the clamp 12 is positioned on the hitch 14. In this way the shield 40 inhibits a person from striking their legs against the ball 42 when the person walks near the hitch 14.

The shield 40 has a first end 44, a second end 46 and a first surface 48 extending therebetween, and the shield 40 is elongated between the first 44 and second 46 ends. The first surface 48 is concavely arcuate between each of the first 44 and second 46 ends. Additionally, the distal end 38 of each of the supports 36 is coupled to the first surface 48. Thus, an axis extending through each of the first 44 and second 46 ends of the shield 40 is horizontally oriented when the clamp 12 is positioned on the hitch 14.

A tether 50 is coupled to the clamp 12 and extends toward the shield 40 and the tether 50 has a distal end 52 with respect to the clamp 12. A grip 54 is coupled to the tether 50 and the grip 54 has a pair of jaws 56 that are biased toward each other. Each of the jaws 56 is positionable around a stem 58 of the ball 42 on the hitch 14 when the clamp 12 is positioned on the hitch 14. Thus, the grip 54 and the tether 50 inhibit the clamp 12 and the shield 40 from falling off of the vehicle 16 if the clamp 12 inadvertently disengages the hitch 14. Each of the jaws 56 on the grip 54 has an inwardly facing surface 58 and the inwardly facing surface 58 of each of the jaws 56 on the grip 54 has a plurality of teeth 60 thereon for frictionally engaging the stem of the ball 42.

In use, the clamp 12 is lowered onto the hitch 14 until the prominence 28 on each of the first 18 and second 20 jaws of the clamp 12 abuts the top side 30 of the hitch 14. The pin 34 is extended through the pin aperture 32 in each of the first 18 and second 20 jaws on the clamp 12 thereby securing the clamp 12 on the hitch 14. Thus, the shield 40 is spaced rearwardly from the ball 42 and the shield 40 forms an arc that partially surrounds the ball 42. Thus, the shield 40 protects the person from striking the person's legs against the ball 42 when the person is walking near the ball 42. The grip 54 is positioned around the ball 42 thereby ensuring the clamp 12 and the shield 40 are not lost if the clamp 12 disengages the hitch 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bumper hitch shield assembly being configured to inhibit a person from striking their legs against a bumper hitch on a vehicle, said assembly comprising:
a clamp releasably engaging a hitch on a vehicle;
a plurality of supports, each of said supports being coupled to and extending away from said clamp, each of said supports being horizontally oriented when said clamp is positioned on the hitch; and
a shield being coupled to each of said supports such that said shield is spaced from said clamp, said shield being curved such that said shield extends around a ball on the hitch when said clamp is positioned on the hitch wherein said shield is configured to inhibit a person from striking their legs against the ball when the person walks near the hitch.

2. The assembly according to claim 1, wherein:
said clamp has a first jaw being spaced from a second jaw to define a hitch space between said first and second jaws, each of said first and second jaws having a inwardly facing surface and a distal end;
each of said first and second jaws having a prominence on said inwardly facing surface, said prominence being centrally positioned on each of said first and second jaws, said prominence on each of said first and second jaws abutting a top side of the hitch when said hitch space receives the hitch; and
each of said first and second jaws having a pin aperture extending therethrough, said pin aperture being positioned adjacent to said distal end of a respective one of said first and second jaws, said pin aperture in each of said first and second jaws being positioned below the hitch when said clamp is positioned around the hitch.

3. The assembly according to claim 2, further comprising a pin being extended through said pin aperture in each of said first and second jaws thereby inhibiting said clamp from being lifted upwardly from the hitch.

4. The assembly according to claim 1, wherein:
said supports radiate outwardly from said clamp, each of said supports having a distal end with respect to said clamp;
said shield has a first end, a second end and a first surface extending therebetween, said shield being elongated between said first and second ends, said first surface being concavely arcuate between each of said first and second ends, said distal end of each of said supports being coupled to said first surface of said shield.

5. The assembly according to claim 2, further comprising a tether being coupled to said clamp and extending toward said shield, said tether having a distal end with respect to said clamp.

6. The assembly according to claim 5, further comprising:
a grip being coupled to said tether, said grip having a pair of jaws being biased toward each other, each of said jaws being positionable around a stem of the ball on the hitch thereby inhibiting said clamp from falling off of the vehicle if said clamp inadvertently disengages the hitch;
each of said jaws on said grip having an inwardly facing surface, said inwardly facing surface of each of said jaws on said grip having a plurality of teeth thereon for frictionally engaging the stem of the ball.

7. A bumper hitch shield assembly being configured to inhibit a person from striking their legs against a bumper hitch on a vehicle, said assembly comprising:
a clamp releasably engaging a hitch on a vehicle, said clamp having a first jaw being spaced from a second jaw to define a hitch space between said first and second jaws, each of said first and second jaws having a inwardly facing surface and a distal end, each of said first and second jaws having a prominence on said inwardly facing surface, said prominence being centrally positioned on each of said first and second jaws, said prominence on each of said first and second jaws abutting a top side of the hitch when said hitch space receives the hitch, each of said first and second jaws having a pin aperture extending therethrough, said pin aperture being positioned adjacent to said distal end of a respective one of said first and second jaws, said pin aperture in each of said first and second jaws being positioned below the hitch when said clamp is positioned around the hitch;
a pin being extended through said pin aperture in each of said first and second jaws thereby inhibiting said clamp from being lifted upwardly from the hitch;
a plurality of supports, each of said supports being coupled to and extending away from said clamp, each of said supports being horizontally oriented when said clamp is positioned on the hitch, said supports radiating outwardly from said clamp, each of said supports having a distal end with respect to said clamp;
a shield being coupled to each of said supports such that said shield is spaced from said clamp, said shield being curved such that said shield extends around a ball on the hitch when said clamp is positioned on the hitch wherein said shield is configured to inhibit a person from striking their legs against the ball when the person walks near the hitch, said shield having a first end, a second end and a first surface extending therebetween, said shield being elongated between said first and second ends, said first surface being concavely arcuate between each of said first and second ends, said distal end of each of said supports being coupled to said first surface;
a tether being coupled to said clamp and extending toward said shield, said tether having a distal end with respect to said clamp; and
a grip being coupled to said tether, said grip having a pair of jaws being biased toward each other, each of said jaws being positionable around a stem of the ball on the hitch thereby inhibiting said clamp from falling off of the vehicle if said clamp inadvertently disengages the hitch, each of said jaws on said grip having an inwardly facing surface, said inwardly facing surface of each of said jaws on said grip having a plurality of teeth thereon for frictionally engaging the stem of the ball.
